(19) United States
(12) Patent Application Publication
(10) Pub. No.: US 2024/0332832 A1
(43) Pub. Date: Oct. 3, 2024

(54) RADIO FREQUENCY COAXIAL CONNECTOR AND SUPPORT BEAD THEREOF

(71) Applicant: ALL BEST PRECISION TECHNOLOGY CO., LTD., Taoyuan City (TW)

(72) Inventor: Haven Yang, TAOYUAN CITY (TW)

(73) Assignee: ALL BEST PRECISION TECHNOLOGY CO., LTD., TAOYUAN CITY (TW)

(21) Appl. No.: 18/139,958

(22) Filed: Apr. 27, 2023

(30) Foreign Application Priority Data
Mar. 31, 2023 (TW) 112112575

(51) Int. Cl. H01R 9/05; H01R 24/54

(52) U.S. Cl. CPC H01R 9/0521; H01R 24/542; H01R 2103/00

(57) ABSTRACT

A radio frequency coaxial connector includes an outer conductor, a central conductor, and a support bead. The outer conductor has a circular through hole extending along a axis. The central conductor is disposed in the circular through hole and extends along the axis. The central conductor has a recess. The support bead is disposed in the circular through hole and has an outer ring, an inner ring, and at least two radial walls. The at least two radial walls are connected to and between the outer ring and the inner ring. The inner ring is sleeved on the central conductor and fits into the recess. The outer ring, the inner ring, and the at least two radial walls form at least two sector-shaped through holes between the outer ring and the inner ring. The at least two sector-shaped through holes extend parallel to the axis.

### BACKGROUND OF THE INVENTION

### 1. Field of the Invention

The present invention relates to a radio frequency coaxial connector, and more particularly to a support bead of the radio frequency coaxial connector.

### 2. Description of the Prior Art

Coaxial components usually have an outer conductor and a central conductor disposed inside the outer conductor. The central conductor is fixed and supported inside the outer conductor by one or more supporting parts. The structure of the supporting parts will affect the electrical and mechanical characteristics of the coaxial components. In signal transmission applications in the microwave frequency band (from a few GHz to 110 GHz or even higher), air is usually used as the dielectric medium to minimize signal loss and influence of radio frequency interference. Therefore, it is practicable to reduce the volume of the supporting parts in design. However, the smaller volume often makes the structural strength of the supporting parts lower, which affects the structural stability (including the support for the central conductor). This phenomenon also creates a dilemma in the design of the supporting parts.

### SUMMARY OF THE INVENTION

An objective of the invention is to provide a radio frequency coaxial connector, which has a support bead with an axially-extending through-hole structure to reduce the impact on signal transmission and maintain the structural strength of the support bead to a certain extent.

A radio frequency coaxial connector of an embodiment according to the invention includes an outer conductor, a central conductor, and a support bead. The outer conductor has a circular through hole. The circular through hole extends along an axis. The central conductor is disposed in the circular through hole and extends along the axis. The central conductor has a recess. The central conductor is fixed and supported inside the outer conductor by the support bead. Therein, the support bead is disposed in the circular through hole and has an outer ring, an inner ring, and at least two radial walls. The outer ring is fixed in the circular through hole and surrounds the axis. The inner ring is located inside the outer ring and surrounds the axis. The at least two radial walls are located between the outer ring and the inner ring and connect the outer ring and the inner ring. The inner ring is sleeved on the central conductor and fits into the recess. The outer ring, the inner ring, and the at least two radial walls form at least two sector-shaped through holes between the outer ring and the inner ring. The at least two sector-shaped through holes extend parallel to the axis.

An objective of the invention is to provide a support bead, used for fixing and supporting a central conductor in a radio frequency coaxial connector. The support bead has an axially-extending through-hole structure to reduce the impact on signal transmission and maintain the structural strength of the support bead to a certain extent.

A support bead used for fixing and supporting a central conductor in a radio frequency coaxial connector of an embodiment according to the invention includes an outer ring, an inner ring, and at least two radial walls. The outer ring surrounds an axis and extends along the axis. The inner ring is located inside the outer ring and surrounds the axis. The at least two radial walls are located between the outer ring and the inner ring and connect the outer ring and the inner ring. The outer ring, the inner ring, and the at least two radial walls form at least two sector-shaped through holes between the outer ring and the inner ring. The at least two sector-shaped through holes extend parallel to the axis. Therein, the inner ring is sleeved on the central conductor to fix and support the central conductor in the radio frequency coaxial connector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a radio frequency coaxial connector according to an embodiment.

FIG. 2 is a sectional view of the radio frequency coaxial connector along the line X-X in FIG. 1.

FIG. 3 is an exploded view of the radio frequency coaxial connector in FIG. 1.

FIG. 4 is a schematic diagram illustrating a support bead in FIG. 3.

FIG. 5 is a side view of the support bead in FIG. 4.

FIG. 6 is a sectional view of the support bead along the line Y-Y in FIG. 5.

### DETAILED DESCRIPTION

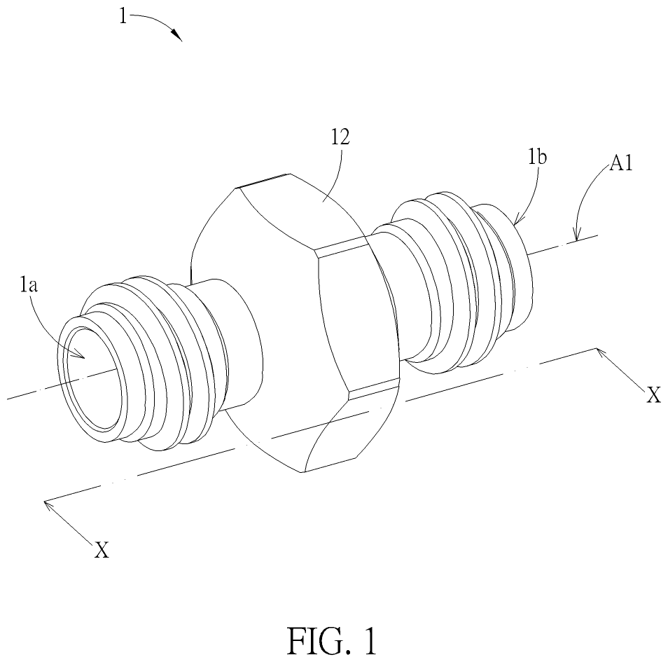

Please refer to FIG. 1 to FIG. 3. A radio frequency coaxial connector 1 according to an embodiment includes an outer conductor 12, a central conductor 14, and a support bead 16. The outer conductor 12 has a circular through hole 12a. The circular through hole 12a extends along an axis A1 (indicated by a chain line in the figures). The central conductor 14 is disposed in the circular through hole 12a and extends along the axis A1. The central conductor 14 is fixed and supported inside the outer conductor 12 by the support bead 16, so that the central conductor 14 is disposed in the circular through hole 12a and extends along the axis A1. On the other hand, the outer conductor 12 and the central conductor 14 coaxially extend (in which the axis A1 is equivalent to the center axis of the outer conductor 12 and the central conductor 14). Through the support bead 16, the central conductor 14 can be disposed stably and spaced apart from the wall surface 12b of the circular through hole 12a. Furthermore, in the embodiment, the central conductor 14 has a recess 14a. The support bead 16 fits into the recess 14a, which helps to maintain the position of the support bead 16 relative to the central conductor 14 (along the axis A1).

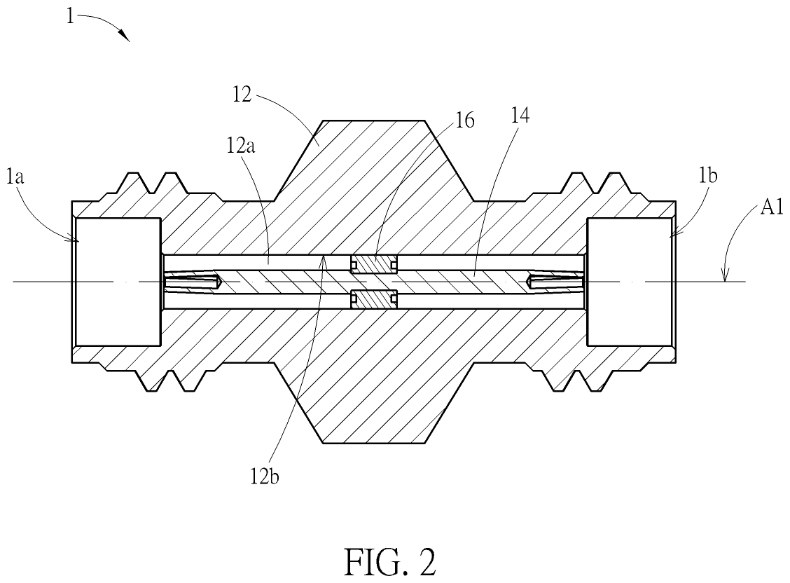

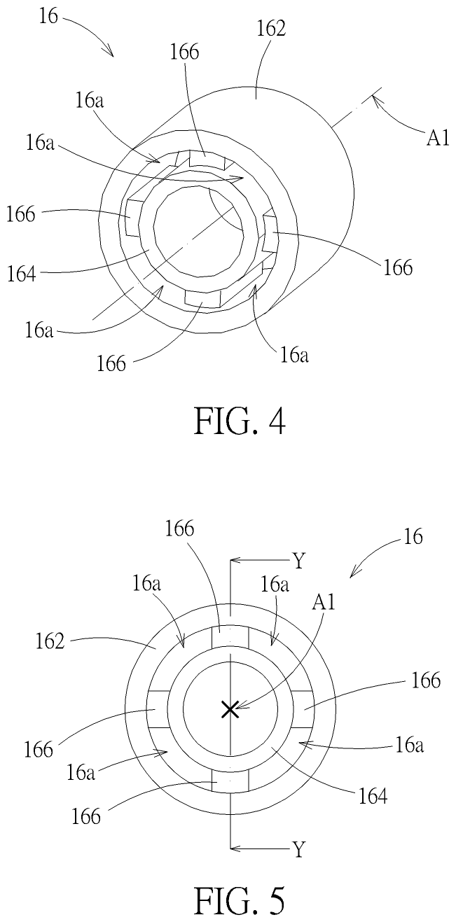

Please refer to FIG. 4 to FIG. 6. In the embodiment, the support bead 16 is disposed in the circular through hole 12a and has an outer ring 162, an inner ring 164, and at least two radial walls 166 (of which the number is four in the embodiment). The outer ring 162 is fixed in the circular through hole 12a (e.g., tightly against the wall surface 12b of the circular through hole 12a) and surrounds the axis A1 (indicated by a cross mark in FIG. 5). The inner ring 164 is located inside the outer ring 162 and also surrounds the axis A1. The radial walls 166 are located between the outer ring 162 and the inner ring 164 and connect the outer ring 162 and the inner ring 164. The inner ring 164 is sleeved on the central conductor 14 and fits into the recess 14a. The outer ring 162, the inner ring 164, and the radial walls 166 form at least two sector-shaped through holes 16a (of which the number is four in the embodiment) between the outer ring 162 and the inner ring 164. The sector-shaped through holes 16a extend parallel to the axis A1. On the other hand, the sector-shaped through holes 16a pass through the whole support bead 16 parallel to the axis A1. The outer ring 162, the inner ring 164, the four radial walls 166, and the four sector-shaped through holes 16a surround the central conductor 14 (also referring to FIG. 2).

As shown by FIG. 5, the four radial walls 166 are evenly distributed and arranged symmetrically relative to the axis A1. This structural configuration helps to maintain the radial structural strength of the support bead 16. In practice, other numbers of radial walls 166 are practicable, such as fewer radial walls 166 (e.g., three or two radial walls 166), or more radial walls 166 (e.g., five or six radial walls 166). In practice, the uniform distribution or symmetrical arrangement of the radial walls 166 is helpful to maintain the radial structural strength of the support bead 16. Furthermore, the radial wall 166 is a plate with uniform thickness and extends along the axis A1 and radially (perpendicular to the axis A1). The connecting portions where the radial wall 166 connects with the outer ring 162 and the inner ring 164 have almost no fillet structure, or although there is a fillet structure, the fillet radius is smaller than the thickness of the radial wall 166 (e.g., less than one-third, one-fourth, one-fifth, etc. of the thickness), which helps to reduce the volume of the support bead 16, thereby reducing the influence of the support bead 16 on signal transmission. In addition, in the embodiment, in the radial direction (perpendicular to the axis A1), the thickness of the outer ring 162 is greater than that of the inner ring 164, which helps to increase the structural stability the peripheral portion of the support bead 16. The thickness (plate thickness) of the radial wall 166 is greater than that of the outer ring 162.

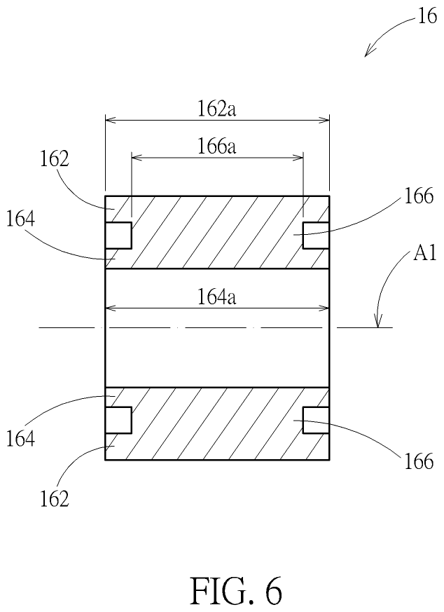

As shown by FIG. 6, the extension length 166a of the radial wall 166 in the direction parallel to the axis A1 is less than the extension length 162a of the outer ring 162 in the direction, and is less than the extension length 164a of the inner ring 164 in the direction. The radial walls 166 are located entirely inside the outer ring 162; that is, the radial walls 166 do not protrude relative to the outer ring 162 in the direction parallel to the axis A1 (i.e., protruding from the circular through hole 12a parallel to the axis A1). This structural configuration helps to reduce the size of the radial wall 166, and also helps to reduce the influence range of the support bead 16 in the direction parallel to the axis A1, thereby reducing the influence of the support bead 16 on signal transmission. Furthermore, the extension length 162a of the outer ring 162 is equal to the extension length 164a of the inner ring 164; however, the structural design of the support bead 16 is not limited thereto in practice. In addition, in the embodiment, the four radial walls 166 have the same structure; however, it is not limited thereto in practice. For example, the extension lengths 166a of the four radial walls 166 are not limited to be the same. For another example, the locations of the four radial walls 166 in the direction parallel to the axis A1 are not limited to be the same.

Furthermore, as shown by FIG. 4 to FIG. 6, in the embodiment, the support bead 16 is one-piece injection part, e.g., a plastic injection part, which helps to reduce the difficulty of making and processing the support bead 16.

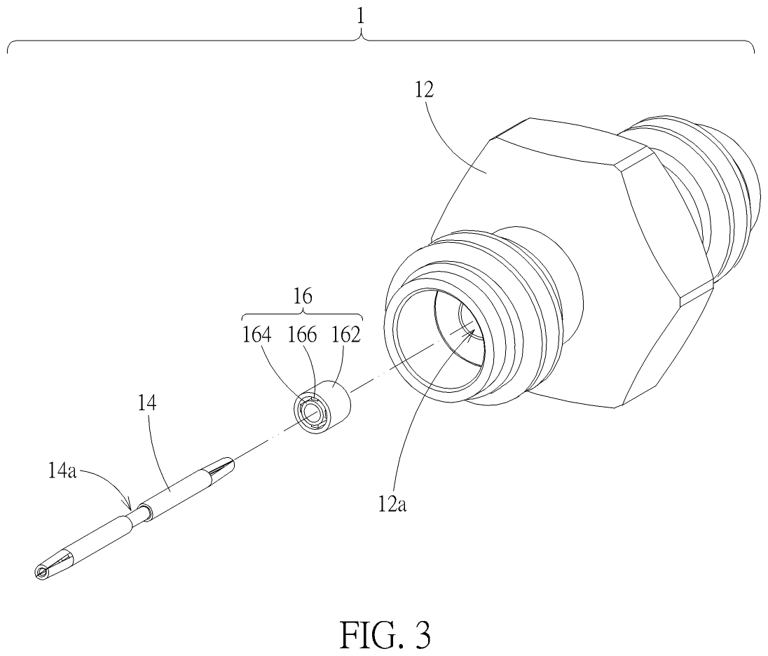

In addition, as shown by FIG. 2 and FIG. 3, in the embodiment, the outer conductor 12 is a single structural part; however, it is not limited thereto in practice. For example, the outer conductor 12 is composed of multiple components. Furthermore, in the embodiment, the radio frequency coaxial connector 1 is an adaptor, both ends 1a and 1b of which are female connection interfaces; however, it is not limited thereto in practice. For example, the two ends 1a and 1b of the radio frequency coaxial connector 1 are a male connection interface and a female connection interface, respectively. For another example, both ends 1a and 1b of the radio frequency coaxial connector 1 are male connection interfaces. In addition, in the embodiment, the central conductor 14 is fixed and supported inside the outer conductor 12 only by the support bead 16. In practice, the radio frequency coaxial connector 1 can be used as an air core microwave connector.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radio frequency coaxial connector, comprising:
an outer conductor, the outer conductor having a circular through hole, the circular through hole extending along an axis;
a central conductor, the central conductor being disposed in the circular through hole and extending along the axis, the central conductor having a recess; and
a support bead, the central conductor being fixed and supported inside the outer conductor by the support bead, wherein the support bead is disposed in the circular through hole and has an outer ring, an inner ring, and at least two radial walls, the outer ring is fixed in the circular through hole and surrounds the axis, the inner ring is located inside the outer ring and surrounds the axis, the at least two radial walls are located between the outer ring and the inner ring and connect the outer ring and the inner ring, the inner ring is sleeved on the central conductor and fits into the recess, the outer ring, the inner ring, and the at least two radial walls form at least two sector-shaped through holes between the outer ring and the inner ring, and the at least two sector-shaped through holes extend parallel to the axis.

2. The radio frequency coaxial connector according to claim 1, wherein the radial wall is a plate with uniform thickness.

3. The radio frequency coaxial connector according to claim 1, wherein the at least one radial walls are provided in an even number, and the at least two radial walls are arranged symmetrically relative to the axis.

4. The radio frequency coaxial connector according to claim 1, wherein an extension length of the radial wall in a direction parallel to the axis is less than an extension length of the outer ring in the direction, and is less than an extension length of the inner ring in the direction.

5. The radio frequency coaxial connector according to claim 1, wherein the at least two radial walls are located entirely inside the outer ring.

6. The radio frequency coaxial connector according to claim 1, wherein the support bead is a one-piece injection part.

7. The radio frequency coaxial connector according to claim 1 being an adaptor.

8. A support bead, used for fixing and supporting a central conductor in a radio frequency coaxial connector, the support bead comprising:
an outer ring, the outer ring surrounding an axis and extending along the axis;
an inner ring, the inner ring being located inside the outer ring and surrounding the axis; and
at least two radial walls, the at least two radial walls being located between the outer ring and the inner ring and connecting the outer ring and the inner ring, the outer ring, the inner ring, and the at least two radial walls forming at least two sector-shaped through holes between the outer ring and the inner ring, the at least two sector-shaped through holes extending parallel to the axis;
wherein the inner ring is sleeved on the central conductor to fix and support the central conductor in the radio frequency coaxial connector.

9. The support bead according to claim 8, wherein the radial wall is a plate with uniform thickness.

10. The support bead according to claim 8, wherein the at least one radial walls are provided in an even number, and the at least two radial walls are arranged symmetrically relative to the axis.

11. The support bead according to claim 8, wherein an extension length of the radial wall in a direction parallel to the axis is less than an extension length of the outer ring in the direction, and is less than an extension length of the inner ring in the direction.

12. The support bead according to claim 8, wherein the at least two radial walls are located entirely inside the outer ring.

13. The support bead according to claim 8, wherein the support bead is a one-piece injection part.
